(19) United States
(12) Patent Application Publication
(10) Pub. No.: US 2008/0256868 A1
(43) Pub. Date: Oct. 23, 2008

(54) NARROW PROFILE WINDOW DRIVE MECHANISM

(76) Inventors: Thomas J. Heppner, Warroad, MN (US); Stephen Donald Fisher, Warroad, MN (US); Gregory J. Vetter, Owatonna, MN (US)

Correspondence Address: SCHWEGMAN, LUNDBERG & WOESSNER, P.A., P.O. BOX 2938, MINNEAPOLIS, MN, 55402, US

(21) Appl. No.: 12/062,468

(22) Filed: Apr. 3, 2008

Related U.S. Application Data
(60) Provisional application No. 60/909,914, filed on Apr. 3, 2007.

(51) Int. Cl. E05F 11/00

(52) U.S. Cl. 49/324; 49/506

(57) ABSTRACT

A window assembly including a frame having an interior portion with an inner surface. A sash is movably coupled with the frame, and the inner surface is substantially parallel with the sash in a closed position. A window drive mechanism is coupled between the frame and the sash, and the mechanism is entirely contained between the inner surface and the sash. The mechanism includes at least one arm rotatably coupled between the frame and the sash.

### RELATED APPLICATION

This application claims the benefit of U.S. Provisional Application Ser. No. 60/090,914 filed Apr. 3, 2007, which application is incorporated by reference and made a part hereof.

### TECHNICAL FIELD

Window hardware, and in particular narrow profile window hardware coupled along a window frame.

### BACKGROUND

Many current window assemblies include hardware (i.e., window drive mechanisms) to facilitate opening of the window by the operator. Casement windows are one example of a window assembly with hardware used on the window sash. The casement window sash rotates from a closed position to an open position with respect to the window frame. The hardware includes a user input, such as a crank, that actuates a mechanism in the hardware to move the window between the open and closed positions. In some examples, the hardware is coupled along the sill of the window assembly for easy access by the operator.

In many examples, the hardware extends beyond the plane of the window frame and thereby protrudes away from window assembly. The hardware extends away from the window frame because of the space needed for the hardware mechanism. The protruding hardware undesirably interferes with drapes, curtains and the like. Additionally, the hardware extends away from the frame during shipping and because of its metal construction may cause damage to adjacent window frames stored against the hardware. Further, because the hardware is prominently placed along the window frame, the hardware detracts from the appearance of the rest of the window, for instance, finished wood, painted frames or sashes, and/or extends into the daylight opening of the window. The hardware breaks up the finished appearance of the window frame and provides an unappealing feature to the window. The large size of some casement window sashes in the past has required correspondingly large hardware to facilitate movement of the window sashes. The larger hardware even further detracts from the appearance of the window assembly. Moreover, in still other examples, the window drive mechanism is used with atypical oversized frames and jamb extensions used with deeper wall construction (e.g., distances between the sash in the closed position and the inner-most portion of the frame greater than 3.125 inches). Oversized frames and jamb extensions, when used in standard wall construction, noticeably extend outside the plane of the wall and thereby decrease the aesthetic appeal of the window.

In other examples, manufacturing of window assemblies is made difficult by the relatively large size of the hardware installed in the assemblies. For instance, the hardware includes relatively large and cumbersome (e.g., long) components with correspondingly large moments of inertia, such as more than 0.45 pounds-mass-inches². The cumbersome hardware components are difficult to handle by hand or with precision machinery. Additionally, in some examples, the frame requires extensive cutting and forming to receive the large hardware.

### BRIEF DESCRIPTION OF THE DRAWINGS

FIG. 1 is a front perspective view of one example of a window assembly with the sash in a closed position, and the window assembly includes a narrow profile window drive mechanism.

FIG. 2 is a front perspective view of the window assembly with the sash in an open position.

FIG. 3 is a detailed perspective view of the window assembly with one example of the window drive mechanism installed in the window frame

FIG. 4 is an exploded view of another example of the window drive mechanism.

FIG. 5 is a top view of another example of the narrow profile window drive mechanism.

FIG. 6 is side perspective view on another example of the window assembly.

FIG. 7 is a cross sectional view of the window drive mechanism with the window assembly.

FIG. 8 is a top view of the window drive mechanism with the window assembly.

FIG. 9 is another top view of the window drive mechanism with the window assembly.

FIG. 10 is a detailed perspective view of still another example of the window drive mechanism with the window assembly, and the window drive mechanism is at least partially concealed with a veneer.

FIG. 11 is a block diagram showing one example of a method for making a window assembly.

FIG. 12 is a cross sectional view of another example of a window assembly with the sash in a closed position, and the window assembly includes another example of a narrow profile window drive mechanism.

FIG. 13A is a perspective view of one example of a single arm narrow profile window drive mechanism.

FIG. 13B is a top view of the single arm narrow profile window drive mechanism example.

FIG. 13C is a side elevational view of the single arm narrow profile window drive mechanism example.

FIG. 14 is a detailed cross sectional view of the window assembly of FIG. 12.

FIG. 15 is another side elevational view of the single arm narrow profile window drive mechanism example.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

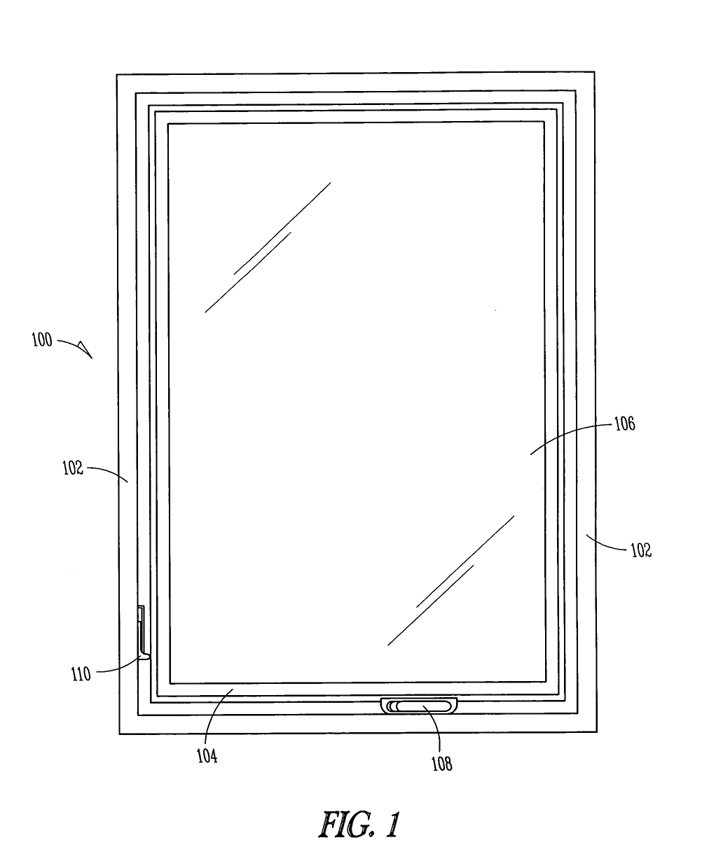

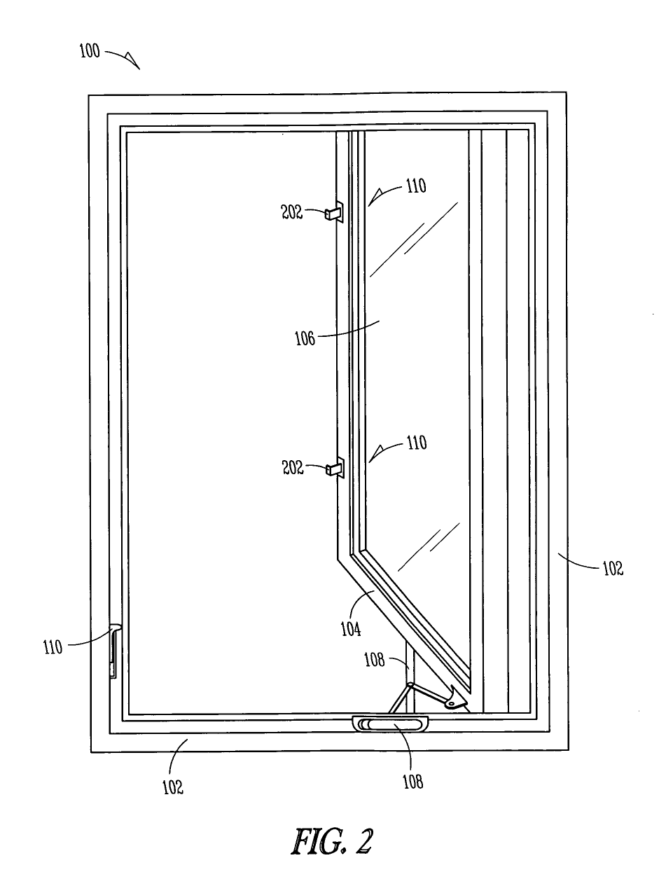

One example of a window assembly 100 is shown in FIGS. 1 and 2. The window assembly 100 includes, optionally, a casement window. The window assembly 100 includes a frame 102 and sash 104 rotatably coupled with the frame 102. In one example, at least one pane of glass 106 is retained within the sash 104. Hardware, such as a window drive mechanism 108, is coupled with the frame 102 and operated to move the sash 104 between a closed position (FIG. 1) and an open position (FIG. 2). As shown in FIG. 2, the window drive mechanism is coupled between the frame 102 and the sash 104.

In another option, the window assembly 100 includes a locking mechanism 110 coupled along the frame 102. The locking mechanism 110 retains the sash 104 along the frame 102 and prevents opening of the window assembly 100. The locking mechanism 110 is operated to allow movement of the sash 104 to the open position shown in FIG. 2. As shown in FIG. 2, in one option, the locking mechanism 110 includes a lever 200 and one or more latches 202. The latches 202 are engaged by features within the frame 102 according to movement of the lever 200, thereby locking the sash 104 in the closed position (FIG. 1).

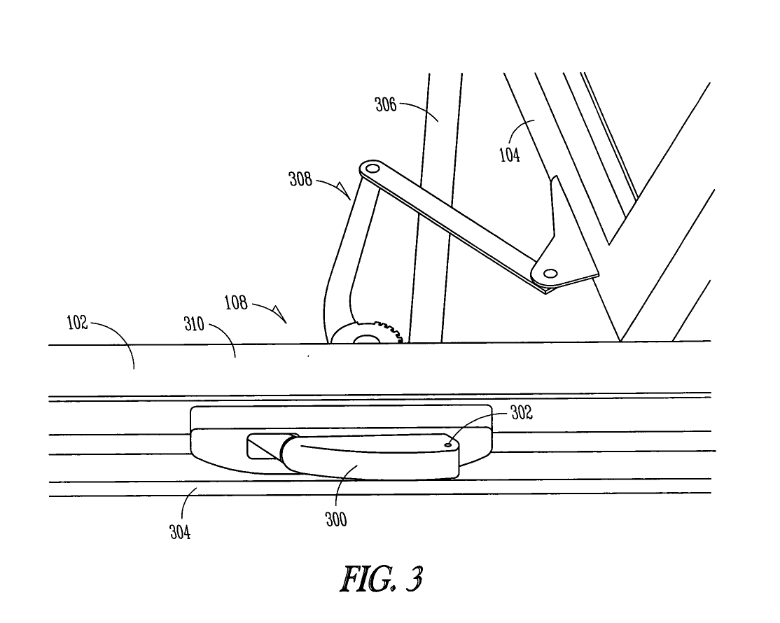

Referring now to FIG. 3, one example of the window drive mechanism 108 is shown in detail coupled between the frame 102 and the sash 104 while the sash 104 is in the open position. As shown, in one option, the window drive mechanism 108 includes a crank 300 folded along the window drive mechanism 108. The crank 300 is rotated to operate the window drive mechanism 108 and move the sash 104 between the open and closed positions. The window drive mechanism 108 includes, in the example shown in FIG. 3, a first arm 306 and a second arm 308 movably coupled between the sash 104 and the frame 102. The arms 306, 308 are further described below. At least a portion of the window drive mechanism 108 is concealed within the window assembly 100, in another option, with part of the frame 102. In yet another option, a portion of the window drive mechanism 108 is concealed by a veneer 310 coupled with the frame 102 over the mechanism. The veneer 310 and the frame 102 cooperate to conceal the window drive mechanism and present a consistent aesthetic appearance. The window drive mechanism is constructed with a metal in another option, such as, steel. In yet another option, the window drive mechanism is constructed with, but not limited to, carbon steel, stainless steel, brass, plastic and the like. Optionally, the components of the window drive mechanism are constructed by, but not limited to, casting, machining, forging, molding and the like.

After positioning of the window (e.g., in the open, closed or a position therebetween), optionally, the crank 300 is folded at a hinge 302 on the window drive mechanism 108 to position the crank 300 along the window drive mechanism 108, as shown in FIG. 3. When positioned along the window drive mechanism 108, the crank 300 is substantially prevented from interfering with curtains, drapes and the like. The crank 300 and the window drive mechanism 108 are contained between the sash 104 and the inner-most portion 304 (i.e., with respect to the interior of a building) of an interior portion of the frame 102, as shown in FIG. 3. In another option, the crank 300 and the window drive mechanism 108 are substantially positioned behind a plane defined by the inner-most portion 304, and thereby do not project beyond the plane of the window assembly 100. In one example, the inner-most portion 304 includes the inner surface of the frame 102 extending around the perimeter of the window assembly 100 and substantially parallel with the sash 104 when the sash is in the closed position (See FIG. 1). The window drive mechanism 108 including the crank 300 in the folded position do not break the plane of the inner-most portion 304. As further described below, the compact window drive mechanism 108 of the window assembly 100 does not obstruct curtains, drapes and the like. The compact nature of the window drive mechanism 108 minimizes the appearance of the mechanism along the frame 102 and sash 104, and thereby maintains the pleasing aesthetic appearance of the window assembly 100. Additionally, because the window drive mechanism 108 does not project beyond the inner-most portion, complicated and costly packing of the window assembly 100 is avoided and damage from the mechanism to adjacently packed window assemblies is precluded.

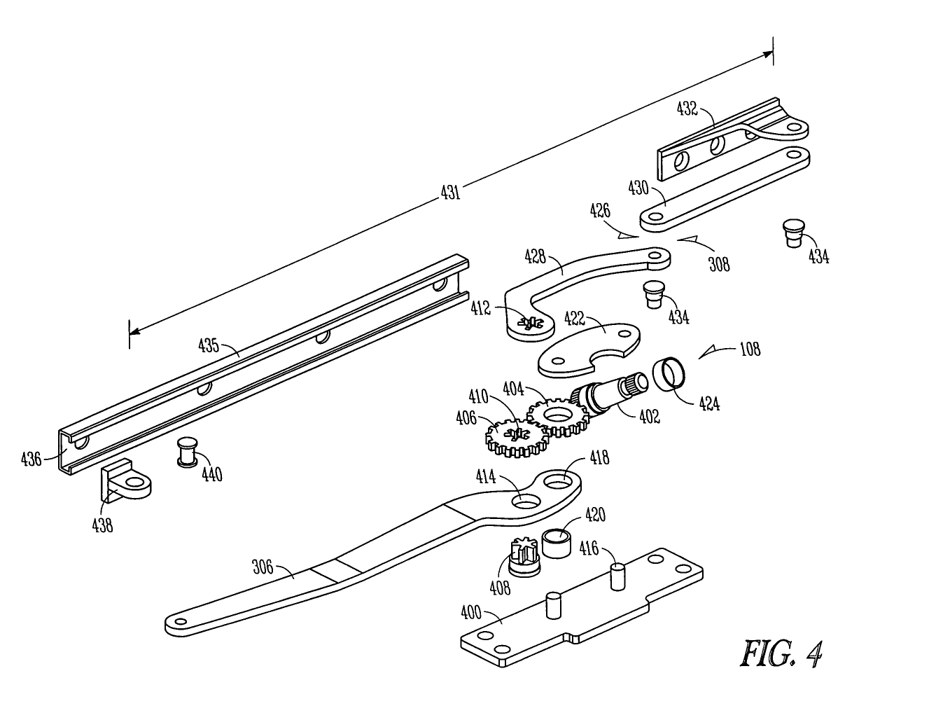

One example of the window drive mechanism 108 is shown in FIG. 4 in an exploded view. In one option, the window drive mechanism 108 includes a base plate 400, and the base plate is adapted for coupling with the frame 102 (FIGS. 1-3). The first arm 306 and the second arm 308 are movably coupled with the base plate 400. For instance, the first and second arms 306, 308 are rotatably coupled with the base plate 400. In another option, a worm gear 402 is coupled with the base plate 400 at an angle of approximately 45 degrees. The crank 300 (FIG. 3) is coupled with the worm gear 402 to operate the window drive mechanism 108. The worm gear 402 is movably coupled with a drive gear 404, and the drive gear 404 is in turn coupled with a driven gear 406. Optionally, the window drive mechanism 108 includes a base cover 422 adapted to couple with the base plate 400. The base cover 422 and the base plate 400 cooperate to retain the worm gear 402, drive gear 404 and the driven gear 406 in position within the window drive mechanism 108. A non-circular pin 408 is coupled with the first arm 306, driven gear 406 and the second arm 308. As shown in FIG. 4, in yet another option, the non-circular pin 408 is positionable within corresponding non-circular openings 410, 412 in the driven gear 406 and the second arm 308, respectively. Relative rotation between the second arm 308 and the driven gear 406 is thereby substantially prevented. Because the first arm 306 includes a first circular opening 414, the first arm 306 is free to rotate around the non-circular pin 408. The base plate 400 further includes an anchor pin 416 sized and shaped to extend through a second circular opening 418 in the first arm 306. The first arm 306 rotates around the anchor pin 416 during opening and closing operations of the window assembly 100. In still another option, an anchor bushing 420 is interposed between the surface defining the second circular opening 418 and the anchor pin 416. The anchor bushing 420 is constructed with, but not limited to, a metal such as brass, to facilitate rotation of the first arm 306 around the anchor pin 416. A worm gear bushing 424 is coupled around the worm gear 402, in an additional option, to facilitate rotation of the worm gear 402 during opening and closing of the window assembly 100.

As described above, the window drive mechanism 108 includes the first and second arms 306, 308. In one option, the second arm 308 includes a joint 426 between a first member 428 and a second member 430. The first member 428 includes the non-circular opening 412 and is rotatably coupled with the base plate 400 and the second member 430. The second member 430 is rotatably coupled with the first member 428 and a first sash bracket 432. As shown in FIG. 4, optionally, fasteners 434, including, but not limited to a rivets, pins, and the like are used to couple the first and second members 428, 430 together at the joint 426, and also couple the second member 430 with the first sash bracket 432. The first arm 306 is slidably coupled with a second sash bracket 435, in another option. The sash bracket 435 includes, optionally, a track 436 sized and shaped to receive a slide 438, and the slide is in turn rotatably coupled with the arm 306. A fastener 440, including, but not limited to a rivet, pin and the like is used to couple the first arm 306 with the slide 438 and second sash bracket 435. The first and second arms 306, 308 are separately coupled with the frame 102 through the driven gear 406 and drive gear 404 coupled with the base plate 400. In another option, the first and second arms are coupled with the frame 102 without the base plate, for example, with the driven gear 406 and drive gear 404 coupled directly to the frame 102.

In operation, rotation of the worm gear 402 (e.g., with the crank 300 shown in FIG. 3) rotates the drive gear 404 thereby rotating the driven gear 406. The non-circular pin 408 is rotated by the driven gear 410 and correspondingly rotates the first member 428 of the second arm 308. The second member 430 rotates with the first member 428 and correspondingly pulls the sash 104 (FIGS. 1 and 2) into the open position or pushes the sash 104 into the closed position. At the same time, the driven gear 406 rotates around the drive gear 404, for instance, as a planetary gear. The non-circular pin 408 is positioned within the non-circular opening 410 of the driven gear 406 and also positioned in the first circular opening 414 of the first arm 306. Rotation of the driven gear 406 around the drive gear 404 is thereby transmitted through the non-circular pin 408 to the first arm 306, and the first arm 306 rotates around the anchor pin 416. The first arm 306 pushes the sash 104 into the open position or pulls the sash 104 into the closed position. The first arm 306 and the second arm 308 cooperate and apply opening and closing forces to the sash 104 at the same time. Because both arms 306, 308 are separately coupled between the frame 102 and the sash 104 through the mechanism described above, the sash 104 is easily opened and closed without unnecessary exertion from the user. For example, the input force of the user through the crank 300 is communicated through the drive gear 404, driven gear 406 and the non-circular pin 408 at the frame 102 and transmitted separately along the arms 306, 308 to distinct portions of the sash 104 (e.g., brackets 432, 434). The spacing 431 between the bracket 432 and the slide 438 ensures the arms 306, 308 transmit forces to differing parts of the sash 104. Transmitting the input force to separate locations with separate arms provides pulling and pushing forces to the sash 104 at the same time and thereby minimizes the force needed to open and close the window assembly 100. The pushing force and pulling force create complementary moments around the sash 104 and thereby facilitate easy opening and closing of the sash 104.

Optionally, the window drive mechanism 108 is used with window assemblies having larger sashes. As described above, the window drive mechanism 108 with the opposed pushing and pulling arms 306, 308 minimizes the force needed to open and close the sash 104. In another option, the pushing and pulling arms 306, 308 multiply the force supplied by the operator to open and close heavy and/or cumbersome sashes. In one option, the window drive mechanism 108 is used with sashes having a weight of 55 pounds or more. In yet another option, the window drive mechanism 108 is used with sashes having a width of 26 inches or more. In still another option, the window drive mechanism 108 is sued with sashes having a width of 30 inches or more and a length of 50 inches or more.

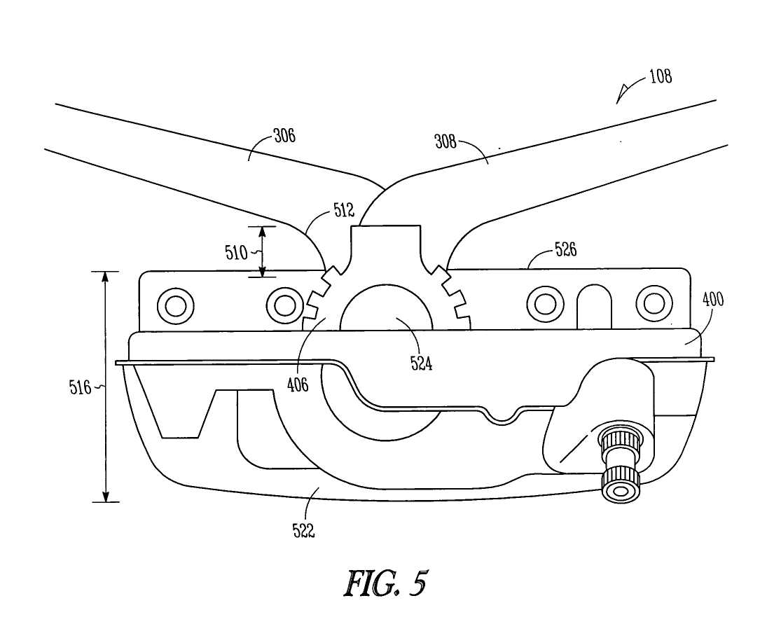

Referring now to FIG. 5, an example of the narrow profile window drive mechanism 108 is shown, as described above. A variety of the features of the window drive mechanism 108 facilitate the compact mechanism design for containment between the sash 104 and the inner-most portion 304 of the window assembly 100 (FIG. 3). For instance, the first arm 306 of the window drive mechanism 108 has a minimal length between a bend 512 and the driven gear 406. The bracketed line 510 shows the length. Because the first arm 306 of the window drive mechanism 108 is shorter between the bend 512 and the driven gear 406, the first arm 306 is retained at a much closer position to the mechanism 108 when the sash 104 (FIGS. 1-3) is in the closed position. Because the first arm 306 and the mechanism 108 are held closely together, the mechanism 108 is correspondingly retained at a closer position to the sash 104, and in one option, is entirely positioned between the inner-most portion 304 and the sash 104 (FIG. 3). Further, because of the minimal length between the bend 512 and the driven gear 406 (see line 510), the base plate 400 is correspondingly more narrow (see bracketed line 516) relative to conventional base plates. The narrow base plate 400 easily fits between the inner-most portion 304 of the window frame 102 and the sash 104 (FIG. 3). Moreover, the pivot point 524 of the first and second arms 306, 308 is positioned substantially adjacent to the bend 512. For instance, as described above, the length shown by the bracketed line 510 is minimized so the pivot point 524 is substantially adjacent to an edge 526 of the base plate 400. In another example, the pivot point 524 is substantially adjacent to a near edge of the frame 102. Optionally, the pivot point 524 is less than ⅞ of an inch from the edge 526. In another option, the pivot point 524 is adjacent to the sash 104, when the sash is in the closed position (See FIG. 1). Because the pivot point 524 is positioned closely to the edge 526 and the sash 104 (in the closed position), the size shown with the bracketed line 516 of the base plate 400 is minimized, thereby facilitating placement of the window drive mechanism 108 between the inner-most portion 304 of the window frame 102 and the sash 104.

In another option, the arm 306 directly engages against the base shell 522 of the mechanism 108 because of the smaller length 510 between the bend 512 and the driven gear 406. Because of the smaller length 510, components, such as, stopping projections spaced away from the base shell 522, and used to prevent further rotation of the arm 306 are thereby not needed. The base shell 522 and other components of the low-profile mechanism 108 (e.g., drive gear 404, driven gear 406 and the like) are thereby held much closer to the first arm 306 to minimize the profile of the mechanism 108 and retain the mechanism within the inner-most portion 304 of the window frame 102 (FIG. 3). In yet another option, the window drive mechanism 108 is substantially located behind a plane defined by the inner-most portion, as described below.

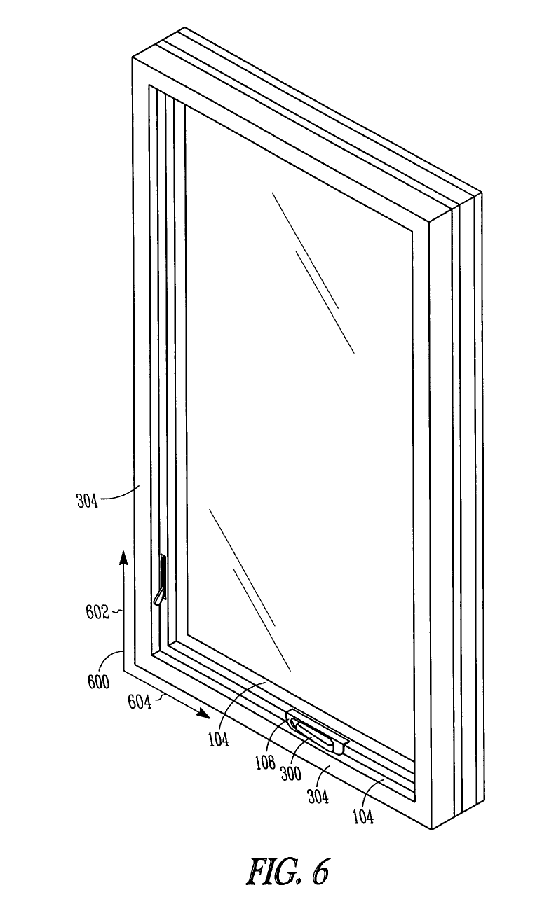

Another example of the window assembly 100 with the low-profile window drive mechanism 108 is shown in FIG. 6. The low-profile window drive mechanism 108 is fully contained within the window assembly 100. For instance, the window drive mechanism 108 is substantially contained between the sash 104 and the inner-most portion 304 of the frame 102. In another option, the window drive mechanism 108 does not extend beyond an exterior surface of the window assembly 100 (e.g., outside of the volume defined by the frame 102). In yet another option, the window drive mechanism 108 is substantially positioned behind a plane 600 defined by the inner-most portion 304 of the frame. As shown in FIG. 6, the plane 600 extends along axis lines 602, 604 that follow the inner-most portion 304 of the frame 102. The window drive mechanism 108 thereby does not extend beyond the plane 600 (e.g., a plane substantially parallel with the sash 104 and extending across the frame 102 along the inner-most portion 304). Optionally, features of the window drive mechanism 108, for instance, the crank 300 (FIG. 3) in an operable position, may extend beyond the inner-most portion 304. The window drive mechanism 108 including the crank 300 is substantially positioned between the plane 600 and the sash 104 when not in stored orientation, as shown in FIG. 6. Because the window drive mechanism 108 is contained within the window assembly 100, the mechanism 108 does not interfere with the operation or appearance of drapes and curtains placed in front of the window opening (i.e., create a bulge or snag). Additionally, the low-profile of the window drive mechanism 108 minimizes the impact of the drive mechanism on the aesthetic appearance of the window assembly 100.

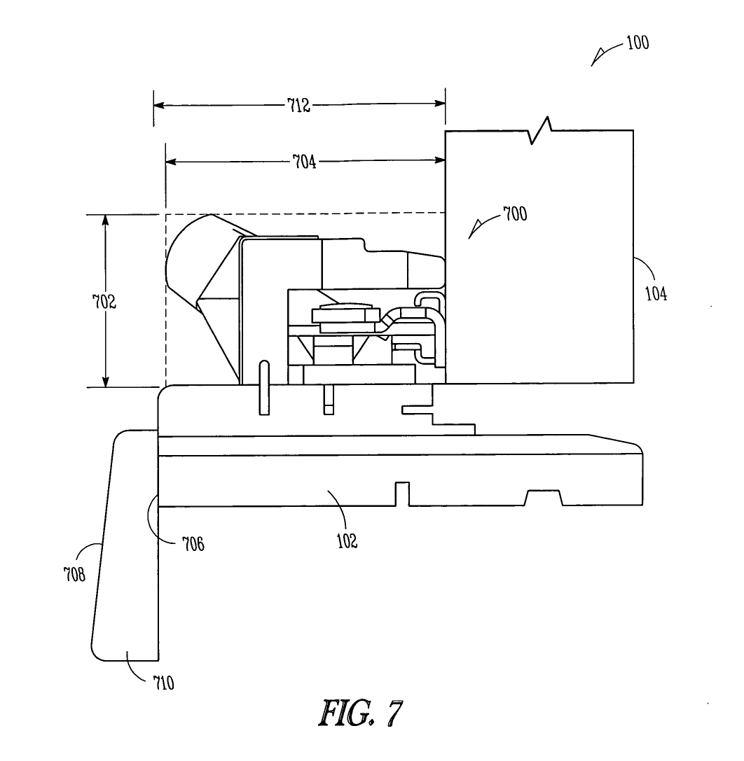

Referring now to FIGS. 7, 8 and 9, profiles of the window drive mechanism 108 are shown. For example, FIG. 7 shows a side profile 700 having a height dimension 702, and a depth dimension 704. Optionally, the side profile 700 is substantially perpendicular to the sash 104 when the sash (FIG. 1-3) is in the closed position. The side profile 700 of the window drive mechanism 108 is entirely contained between the sash 104 and the inner-most portion of the window assembly 100. As described above, the inner-most portion of the window assembly 100 includes the inner surface of the frame 102 extending around the perimeter of the window assembly 100 and substantially parallel with the sash 104 when the sash is in the closed position (See FIG. 1). In one option, the inner-most portion of the window assembly includes the inner-most portion 706 of the frame 102. In another option, the inner-most portion of the frame 102 includes the inner-most portion 708 of the casing 810 extending around the perimeter of the frame 102. In one example, the casing 810 is a decorative trim coupled around the frame 102.

The side profile 700 has a small area (defined by the height 702 and depth 704) relative to other casement window hardware, and the side profile 700 of the window drive mechanism 108 does not penetrate outside of the assembly 100 relative to other casement window hardware. Because the side profile 700 is compact, the window drive mechanism 108 is sized and shaped for installation in a variety of window assemblies having different sizes, while still remaining fully contained within the assemblies and not penetrating outside thereof. Optionally, the window drive mechanism 108 is installed in any of these window sizes without the mechanism 108 or window assembly needing modification, such as additional cutting, machining, changing of parts or the like. In one option, the window drive mechanism side profile 700 has an area of about 3.75 square inches or less. In another option, the side profile 700 has an area of about 3.5 square inches or less.

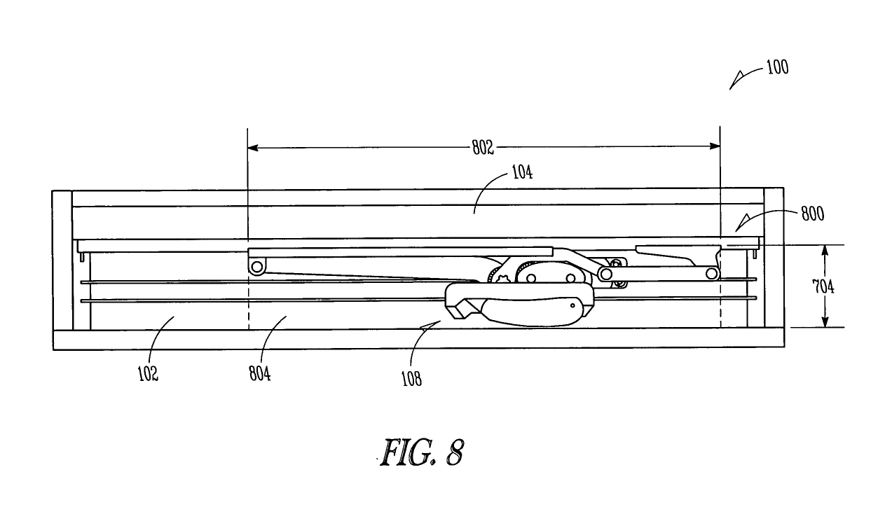

Referring now to FIG. 8, the window drive mechanism 108 is shown coupled along the frame 102. A top profile 800 is shown with a length dimension 802 and the depth dimension 704. As previously described, the window drive mechanism 108 is contained between the inner-most portion of the window assembly 100 and the sash 104. The top profile 800 has a small area (defined by the length 802 and the depth 704) relative to other casement window hardware. Because the window drive mechanism 108 is fully contained between the inner-most portion of the frame (e.g., inner-most portions 706, 708 shown in FIG. 7) and the sash 104, the depth dimension 704 is necessarily small thereby facilitating a small top profile 800. In one option, the top profile 800 has an area of around 52.5 square inches or less. In another option, the top profile 800 has an area of around 45 square inches or less. In yet another option, the top profile 800 has an area of around 37.5 square inches or less. Because the top profile 800 is compact, the window drive mechanism 108 is sized and shaped for installation in a variety of window assemblies having different sizes, while still remaining fully contained within the assemblies and not penetrating outside thereof. Optionally, the window drive mechanism 108 is installed in almost any window size without the mechanism 108 or window assembly needing modification, such as additional cutting, machining, changing of parts or the like. For instance, a variety of window assemblies are sized and shaped to receive a standardized window drive mechanism 108 without any further modification to the window assembly or mechanism 108 because of changes in the window assembly size.

Additionally, a smaller portion of the sill area 804 is covered by the window drive mechanism 108 because of the relatively small depth dimension 704, thereby creating a more aesthetically pleasing appearance for the window assembly 100. In another option, the window drive mechanism 108 is used in window assemblies having standard sized frames and corresponding distances between the sash 104 in the closed position and the inner-most portion 706 (FIG. 7). The distance between the sash 104 and the inner-most portion 706 of the frame 102 is shown by bracketed line 712 in FIG. 7. In one option, the distance between the sash 104 and the inner-most portion 706 is around 3.125 inches or less. In still another option, the distance between the sash 104 and the inner-most portion 706 is around 2.9375 inches or less. In yet another option the distance between the sash 104 and the inner-most portion is around 2.75 inches or less. The compact construction of the window drive mechanism 108, as described above, permits installation of the mechanism 108 between the sash 104 and the inner-most portion 706 in standard sized windows. The window drive mechanism 108 is thereby substantially contained within the window assembly 100 (FIG. 1) without penetrating outside of a plane, such as plane 600 defined by the inner-most portion 304 of the frame 102 (FIG. 6). Features such as atypically deep frames for use with deeper wall construction, jamb extensions and the like are not needed to contain the window drive mechanism 108, and the aesthetic appearance of the standard window frame 102 is thereby maintained. Further still, because the window drive mechanism 108 is compact, the sash 104 is positioned closely to the inner-most portion 706, as shown by the distances represented by the bracketed line 712, above. Positioning the sash 104 closely to the inner-most portion 706 of the window assembly 100 increases the thermodynamic efficiency of the assembly, and thereby facilitates lower cooling and heating costs. The sash 104 is positioned closely to the inner-most portion 706 while the window drive mechanism 108 is still contained within the plane 600 (FIG. 6), as described above, to allow for unobstructed use of shades, curtains and the like.

The top profile 800 has a small area (defined by the length 802 and the depth 704) relative to other casement window hardware. Because the top profile 800 is compact, the window drive mechanism 108 is sized and shaped for installation in a variety of window assemblies having different size constraints, such as, volume available for a window drive mechanism in the frame. Because the window drive mechanism 108 has a relatively small depth, less manufacturing is needed to create sufficient volume within the frame 102 to house the mechanism 108 thereby reducing cost and labor to construct the window assembly 100. In another option, the window drive mechanism 108 extends a relatively small amount from the sash 104 compared with prior art window hardware, thereby minimizing alteration of the clean appearance of the window assembly 100. In one option, the top profile 800 has an area of around 48 square inches or less. In yet another option, the top profile 800 has an area of around 38 square inches or less.

Because the side and top 700, 800 of the window drive mechanism 108 are compact, the volume of the window drive mechanism 108 is also small relative to prior art window hardware. In one option, the compact volume of the window drive mechanism 108 facilitates the installation of the mechanism 108 in a window assembly having a relatively small space available for window hardware (e.g., windows with a narrow sill, shallow sill and the like). In another option, the compact volume of the window drive mechanism 108 reduces manufacturing costs with a window assembly by reducing labor and machining performed to make space in the frame 102 to receive the window drive mechanism 108. Further, the relatively small volume of the window drive mechanism 108 minimizes use of space along the frame 102 and maintains the aesthetic appearance of the window assembly 100. Optionally, the window drive mechanism 108 has a volume of around 70 cubic inches or less. In still another option, the window drive mechanism 108 has a volume of around 62.5 cubic inches or less. In yet another option, the window drive mechanism has a volume of 55 cubic inches or less. The volume measurements provided above are generated by using the overall length, height and depth measurements for the window drive mechanism 108 when compared with similar measurements from prior art window hardware. Correspondingly smaller volume measurements are available with, for instance, water immersion volume tests.

Because the window drive mechanism 108 has a compact design that permits easy installation within the window assembly 100 (FIGS. 1-3) the mechanism has a corresponding low moment of inertia. Moment of inertia (e.g., mass moment of inertia) is a measure of a body's tendency to resist angular acceleration, for instance rotation of the window drive mechanism 108 from a resting position. The moment of inertia of window hardware provides an indication of how difficult it is to maneuver the hardware for installation within the window assembly. For instance, a high moment of inertia (e.g., window hardware having a moment of inertia of 0.5 pounds-mass-inches² or more) is more difficult to rotate by hand or machine, and thereby more cumbersome to install within the window assembly. In one option, the moment of inertia of the window drive mechanism 108 is around 0.39 pounds-mass-inches² or less. In another option, the moment of inertia of the window drive mechanism 108 is around 0.34 pounds-mass-inches² or less. In still another option, the moment of inertia of the window drive mechanism 108 is around 0.32 pounds-mass-inches² or less. In an additional option, the moment of inertia of the window drive mechanism 108 is around 0.27 pounds-mass-inches² or less. The moment of inertia for the window drive mechanism 108, optionally, is measured by using computer-aided solid modeling. Because the window drive mechanism 108 is compact, the corresponding moment of inertia is relatively small thereby facilitating handling of the window drive mechanism 108 during installation in the window assembly 100. Easy handling of the window drive mechanism 108 minimizes machine stress and operator stress, and thereby lowers manufacturing costs.

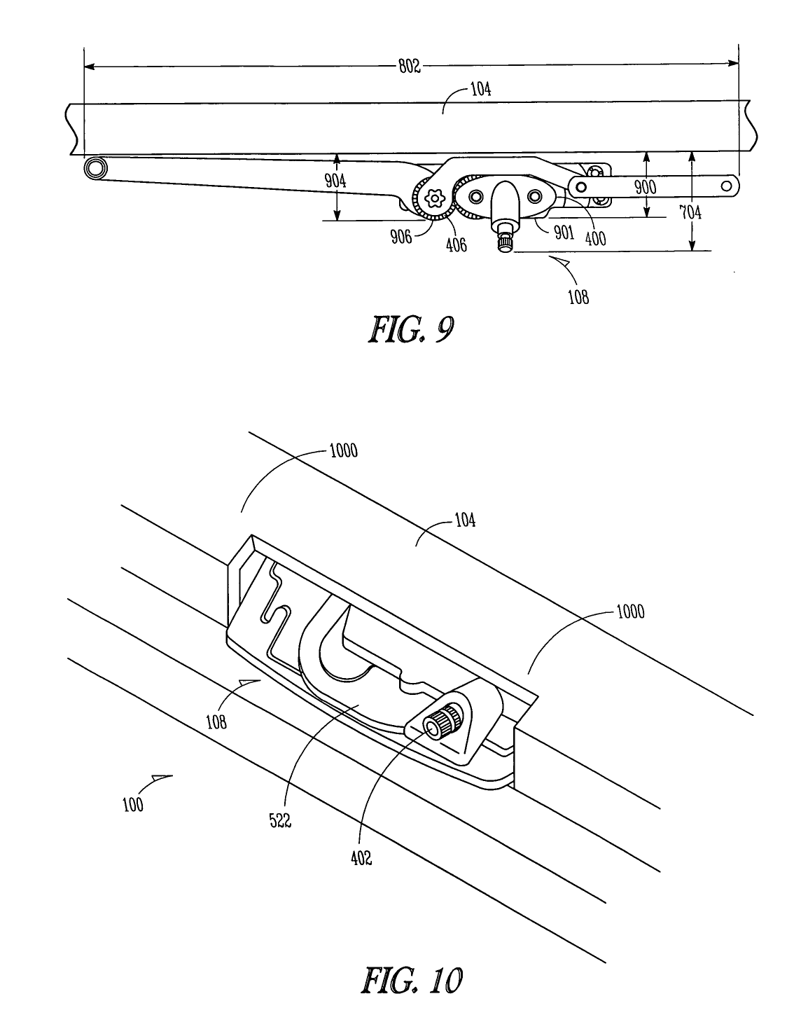

FIG. 9 shows one example of the window drive mechanism 108 with the sash 104 in a closed position. As shown, the window drive mechanism 108 has a base depth 900 extending between the sash 104 in the closed position and an opposed edge 901 of the base plate 400. In one option, the base depth 900 of the window drive mechanism 108 is related to the moment of inertia (I) of the mechanism by the following inequality.

BaseDepth≦−1.625(I)+2.95

In one example, the base depth 900 is equal to 2.3 inches or less and the moment of inertia of the mechanism 108 is equal to 0.34 pounds-mass-inches² or less. In another example, the base depth 900 is equal to 2.3 inches or less and the moment of inertia is equal to 0.27 pounds-mass-inches² or less. By minimizing the base depth 900 and moment of inertia, the window drive mechanism 108 is easily handled and fit within the plane 600 defined by the inner-most portion 304 of the frame 102, as shown in FIG. 6, and described above.

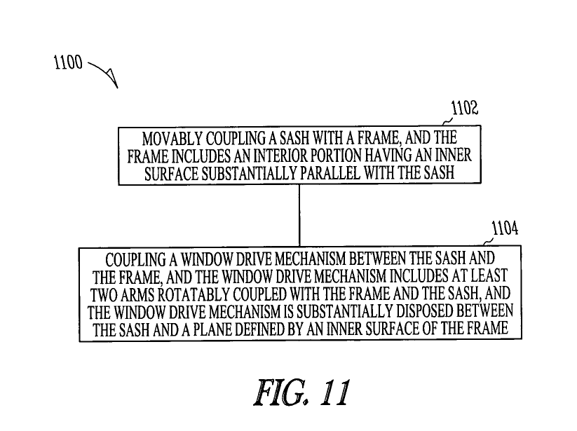

Referring again to FIG. 10, the window drive mechanism 108 has a driven gear depth 904 extending between the sash 104 in the closed position and an opposed edge 906 of the driven gear 406. Additionally, the window drive mechanism 108 has a top profile 800 defined by the length dimension 802 and the depth dimension 704. In another option, the driven gear depth 904 is related to the top profile 800 by the following inequality.

DrivenGearDepth≦−0.625(Top Profile)+33.625

In one example, the driven gear depth 904 is equal to 2.20 inches and the top profile 800 is equal to 48.0 square inches. In yet another option, the driven gear depth 904 is equal to 2.42 inches or less and the top profile 800 is equal to 52.8 square inches or less. Minimizing the driven gear depth 904 and the top profile 800 of the window drive mechanism 108, as described above, facilitates the installation of the mechanism 108 in standard sized window frames 102 without the mechanism 108 extending outside of the plane 600 defined by the inner-most portion 304 of the frame 102 (See FIG. 6). Non-standard frames having additional depth used with construction in larger walls are thereby not needed.

Optionally, the window drive mechanism 108 has a volume defined by the width 802, depth 704 and height 702 (FIG. 7). In one option, the mass of the window drive mechanism 108 is related to the volume by the following inequality.

Volume≦−8.75(Mass)+79.375

In one example, the window drive mechanism volume is equal to 63 cubic inches or less and the mechanism mass is equal to 1.35 pounds or less. In another option, the window drive mechanism volume is equal to 74.35 cubic inches or less and the mechanism mass is equal to 0.81 pounds or less. As described above, the compact size of the window drive mechanism 108 allows for the installation of the mechanism 108 within standard sized window frames without substantially extending outside of the plane 600 of the frame 102 (See FIG. 6). Additionally, the window drive mechanism 108 is relatively light compared to other window hardware and thereby has a lower moment of inertia. The above described properties of the window drive mechanism 108 (e.g., depths, volume, moment of inertia, profiles and the like) are options that show the slender and compact configuration of the mechanism 108 that facilitate positioning of the mechanism between the sash 104 and the inner-most portion of the frame (e.g., surfaces 304, 706 and the like) without interference with curtains, shades and the like.

Referring now to FIG. 10, a portion of the window assembly 100 is shown including the base shell 522 and worm gear 402 of the window drive mechanism 108. As shown, the window drive mechanism 108 is partially exposed to permit access to the mechanism 108 for opening and closing of the sash 104, for instance, by cranking of the worm gear 402. A veneer 1000 extends over the remainder of the window drive mechanism 108 in the closed position, including, but not limited to, the first and second arms 306, 308, drive gear 404, driven gear 406, base plate 400 and the like, as shown in FIG. 4. The veneer 1000 provides an attractive appearance over the window drive mechanism 108. In one option, the veneer 1000 has a similar appearance to the window assembly 100, such as, finished wood, a painted surface, a composite surface, a plastic surface and the like. As previously described, the compact design of the window drive mechanism 108 requires a smaller veneer 1000 to cover the mechanism 108. Optionally, the minimized height 702 and depth 704 dimensions allow for use of a correspondingly smaller veneer 1000 to conceal the window drive mechanism 108. Less material is used to construct the veneer 1000, thereby minimizing the cost of the veneer 1000 for the window assembly 100.

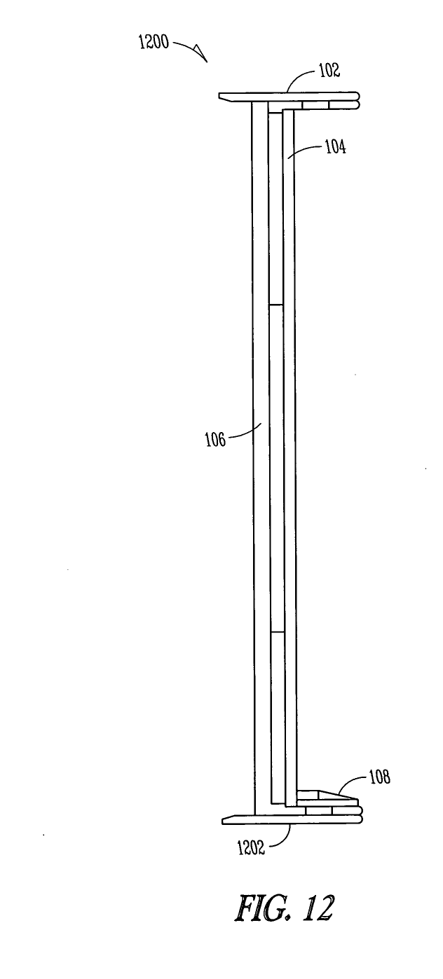

FIG. 11 is a block diagram showing a method 1100 for making a window assembly. At 1102, a sash is movably coupled with a frame. The frame includes an interior portion having an inner surface substantially parallel with the sash. For instance, the inner surface is an inner-most portion of the window assembly, such as inner surface of a window trim. In another option, the inner surface is an inner-most portion of the window assembly including the perimeter of the window frame substantially parallel with the window sash (in the closed position). At 1104, a window drive mechanism is coupled between the sash and the frame. The window drive mechanism is entirely contained between the inner surface and the sash, and includes at least two arms rotatably coupled with the frame and the sash. In one option, the at least two arms are rotatably coupled with a base plate, and the base plate is in turn coupled with the frame. In another option, the at least two arms are coupled with brackets, and the brackets are in turn coupled with the sash. In yet another option, the method 1100 includes slidably coupling a first arm of the at least two arms along the sash.

Several options for the method 1100 follow. In one option, coupling the window drive mechanism includes rotatably coupling a first arm with a second arm near the frame. For instance, the first arm is coupled with the second arm using gearing, such as, a driven gear, a drive gear and a non-circular pin extending through at least one of the driven gear and the drive gear. In another option, the method 1100 includes coupling a veneer over at least a portion of the window drive mechanism, and the veneer is entirely contained between the inner surface and the sash. Optionally, the veneer conceals the at least two arms while the sash is in a closed position adjacent to the window assembly frame. In still another option, the a crank is coupled with the window drive mechanism, and the crank is entirely contained between the inner surface and the sash when in a stored position. The method 1100 includes, in yet another option, opening the sash away from the frame with the first arm pushing the sash at a first location, and the second arm pulling the sash at a second location remote from the first location.

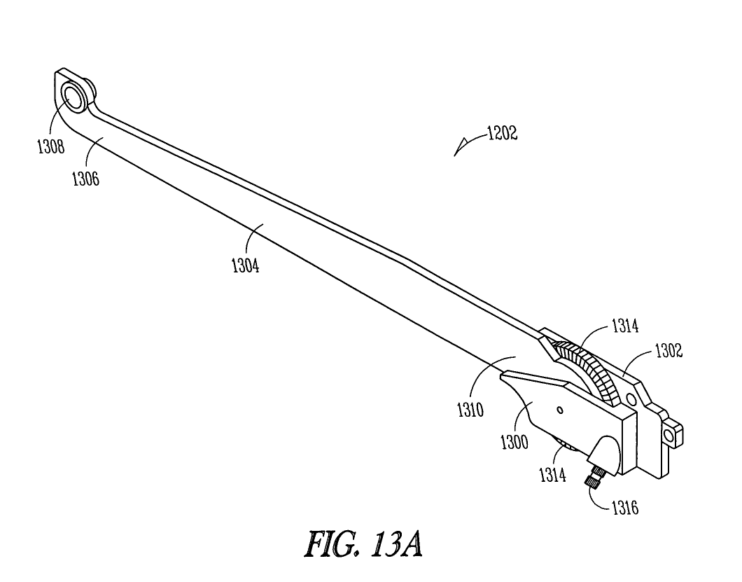

Another example of a window assembly 1200 is shown in FIG. 12. The window assembly 1200, in one example, includes similar features to the window assembly 100 shown in FIGS. 1 and 2. For instance, the window assembly 1200 includes, optionally, a casement window. The window assembly 1200 includes a frame 102 and sash 104 rotatably coupled with the frame 102. In one example, at least one pane of glass 106 is retained within the sash 104. Hardware, such as a window drive mechanism 1202, is coupled with the frame 102 and operated to move the sash 104 between a closed position (FIG. 1) and an open position (FIG. 2). As shown in FIG. 2, the window drive mechanism 1202 is coupled between the frame 102 and the sash 104.

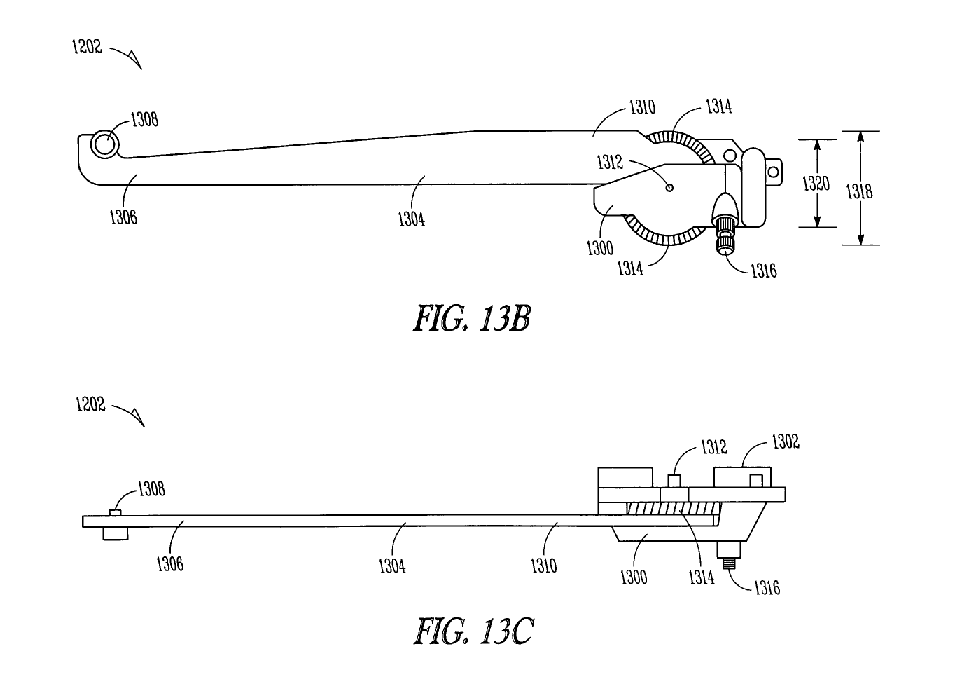

One example of the window drive mechanism 1202 is shown in FIGS. 13A, B, C and 15. The window drive mechanism includes a housing 1300, a base 1302 and at least one arm 1304. In an option, the arm 1304 is a single arm. The arm 1304 is adapted for pivotable coupling between the housing 1300 and a distal end 1306, where the arm 1304 is coupled with the sash 104. The distal end 1306 of the arm is rotatably coupled with the sash, in one example, with a bracket and pin mechanism (e.g., pin or rivet 1308). In another example, the distal end 1306 of the arm is coupled with the sash 104 with a hinge mechanism. As previously shown in FIG. 4, the distal end 1306 of the arm 1304 is coupled with the track 436 sized and shaped to receive the slide 438, and the slide is in turn rotatably coupled with the arm 1304. The proximal end 1310 of the arm 1304 is rotatably coupled with the housing 1300 with a shaft 1312 that facilitates rotation of the arm 1304 with respect to the housing 1300.

In another example, the proximal end 1310 of the arm 1304 is coupled with a driven gear 1314. The driven gear 1314 is rotatably coupled with the housing 1300 and the base 1302, for instance along the shaft 1312. Rotation of the driven gear 1314 correspondingly rotates the arm 1304 and thereby actuates the sash 104 as described further below. Referring again to FIGS. 13A, B, C, the window drive mechanism 1202 includes a spline 1316 sized and shaped to couple with a crank, such as crank 300 (FIG. 3). The spline 1316 is rotatably coupled with the housing 1300 and extends into the housing. The spline 1316, in yet another example, is coupled with an input gear (e.g., a worm gear) that is coupled with the driven gear 1314. In still another example, an intermediate gear (e.g., a drive gear) is coupled between the input gear and the driven gear 1314. Optionally, the driven gear 1314 (or intermediate gear) has a helical configuration to mate with the angled input gear of the spline 1316. As described below, the angle of the spline 1316 lowers the overall height of the mechanism 1202 to minimize interference with the daylight opening of the sash 104 (open or closed).

As shown in FIGS. 13A, B, C, driven gear 1314 has a large diameter 1318 relative to the diameter of the spline 1316. In one example, the driven gear diameter 1318 is larger than the depth 1320 of the housing 1300. Multiple rotations of the smaller spline 1316 correspondingly result in increased torque from the driven gear 1318 and fewer rotations of the driven gear 1318. The window drive mechanism 1202 is thereby able to transmit a significant amount of force to the sash 104 allowing use of the mechanism 1202 with sashes of varying sizes. In one option, the window drive mechanism 1202 is used with a sash measuring around 8 square feet or more. In another option, the window drive mechanism 1202 is used with a sash measuring around 18 square feet. In still another option, the window drive mechanism 1202 is used with a sash measuring around 23 square feet. Optionally, the window drive mechanism is used with sashes having a weight of 55 pounds or more. In yet another option, the window drive mechanism 1202 is used with sashes having a width of 26 inches or more. In still another option, the window drive mechanism 1202 is used with sashes having a width of 30 inches or more and a length of 50 inches or more. In an additional option, the window drive mechanism 1202 is used with sashes having a width of around 40 inches or more and a height of around 91 inches or more. In another example, the driven gear 1318 size is adjusted to a larger size for relatively large windows. In yet another example, the driven gear 1318 size is adjusted to a smaller size for smaller windows to facilitate faster opening of the sash 104 where additional force is not needed for the lighter window. Optionally, even with a large driven gear 1318 relative to a small spline 1316, the crank 300 and spline 1316 need ten or less rotations, or in another option, seven or less rotations to open the sash 104 a full 90 degrees with respect to the frame 102. The single arm window drive mechanism 1202 is thereby quick and easy to use while still able to move large sashes 104.

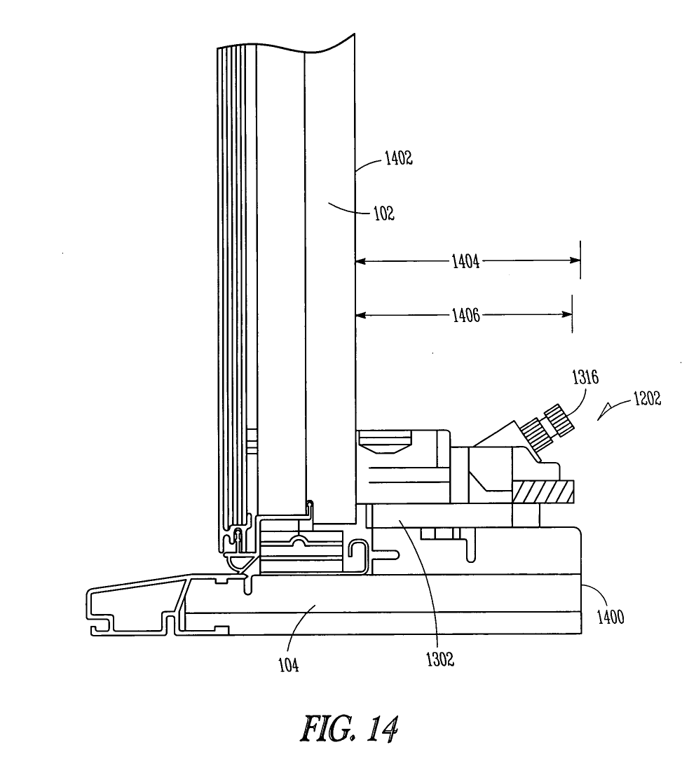

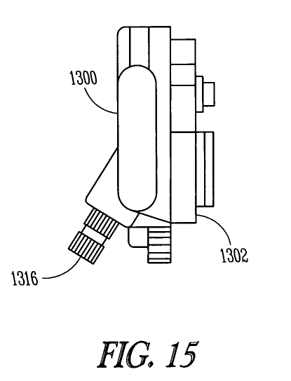

Referring now to FIG. 14, the window drive mechanism 1202 is shown coupled between the window frame 102 and the sash 104. The base 1202 is coupled with the frame 102, for instance, with screws, bolts, pins, adhesives and the like. In another example, the base 1202 is coupled to the frame 102 with a mechanical fittings, such as a snap-lock or snap-fit feature. As previously described above, and shown in FIGS. 4, 13A, B, C, the distal end 1302 of the arm 1304 is coupled with the sash 104 with a bracket, for instance the track 436 sized and shaped to receive a slide 438.

As shown in FIG. 14, the window drive mechanism 1202 is entirely contained within the frame interior plane 1400. The mechanism 1202, including the crank 300 in an example, fails to extend beyond the frame interior plane 1400. The window drive mechanism 1202 thereby provides a clean attractive appearance that doesn't interfere with window treatments. Additionally, the window drive mechanism 1202 will not engage against other windows during shipping and avoids causing damage to the windows. In another example, the window drive mechanism 1202 is fully contained between the sash interior surface 1402 and the frame interior plane 1400. In one option, the distance 1404 between the frame interior plane 1400 and the sash interior surface 1402 is not more than around 2 and 9/16 inches. The depth 1406 of the window drive mechanism 1202 is not more than around 2 and ½ inches and fits between the sash interior surface 1402 and the frame interior plane 1400. Additionally, the height of the window drive mechanism 1202 is minimized to decrease extension of the mechanism into the daylight opening of the sash glass pane 106 or the open window when the sash 104 is opened. Optionally, the window drive mechanism 1202 does not extend into the daylight opening of the sash glass pane 106 or the open window. For instance, the window drive mechanism is concealed within the frame 102, as shown in FIG. 10. In another option, the window drive mechanism 1202 has a height 1408 of not more than 1 and 17/64 inches (measured from the bottom of the base 1302 to the opposed end of the spline 1316) to minimize or eliminate extension of the mechanism into the daylight opening. The measurements provided above are examples and are not intended to be limiting. Because of the small-profile of the window drive mechanism 1202, as described above, the mechanism does not conceal much of the aesthetically appealing frame. The window drive mechanism thereby fails to break up the finished appearance of the window assembly.

The above described window drive mechanism is entirely contained between the sash and an inner-most portion of the window assembly (e.g., the frame, casing around the frame and the like). The window drive mechanism does not break the plane of the inner-most portion of the window assembly, and thereby does not interfere with the operation of window treatments including, but not limited to, curtains, drapes, blinds and the like. Additionally, the window drive mechanism does not engage against the window treatments and push through to detract from the aesthetic appearance of the window treatments. Because the window drive mechanism is substantially contained within the window assembly, the mechanism does not extend away from the assembly and damage adjacent window assemblies during transport. Further, because of the low-profile of the window drive mechanism, for instance, the side and front profiles, the mechanism does not conceal much of the aesthetically appealing frame. The window drive mechanism thereby fails to break up the finished appearance of the window assembly.

Furthermore, because the window drive mechanism is relatively small compared with other window hardware, its moment of inertia is corresponding small as well. The window drive mechanism is thereby not cumbersome and is easily handled by hand or with precision machinery during assembly of the window assembly. Further still, the low-profile of the window drive mechanism facilitates forming of the frame to receive the mechanism, for example, cutting of the frame is minimized to receive the low-profile mechanism. Moreover, the relatively small depth of the window drive mechanism allows the sash to be positioned closely to the inner-most portion of the frame without the mechanism penetrating the plane defined by the inner-most portion. Positioning the sash closely to the inner-most portion of the frame improves the thermodynamic efficiency of the window assembly. Additionally, the small depth of the window drive mechanism allows the mechanism to be fully contained within a standard window frame, for instance, a window frame having a distance between the sash and the inner-most portion of the frame of 3.125 inches or less. Atypical larger window frames for use with deeper wall construction are thereby not needed to contain the window drive mechanism.

Additionally, the window drive mechanism is easily opened and closed because of the arms extending between the frame and the sash. The first and second arms cooperate to provide pushing and pulling forces to separate portions of the sash at the same time. Force is transmitted along both arms separately from the frame where the user inputs a force (e.g., through a crank). The pushing force and pulling force create complementary moments around the sash and thereby facilitate easy opening and closing of the sash. The above described window drive mechanism accomplishes the easy opening and closing movement of the sash with first and second arms while still containing the mechanism between the inner-most portion of the window assembly and the sash. The single arm window drive mechanism similarly accomplishes easy opening and closing movement of the sash through the use of a large driven gear relative to a smaller input gear. The relative sizes of the gears are changed according to the size of the sash, and allow for use of the window drive mechanism with a variety of windows, including windows having large sashes measuring around 23 square feet.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope of the invention should, therefore, be determined with reference to the appended claims, along with the full scope of equivalents to which such claims are entitled.

What is claimed is:

1. A window assembly comprising:
a frame including an interior portion, and the interior portion has an inner surface;
a sash movably coupled with the frame, and the inner surface is substantially parallel with the sash when the sash is in a closed position; and
a window drive mechanism coupled between the frame and the sash, and the window drive mechanism includes at least one arm rotatably coupled between the frame and the sash, and the window drive mechanism is entirely contained between the inner surface and the sash.

2. The window assembly of claim 1, wherein the window drive mechanism includes an input gear and a driven gear, the input gear diameter smaller with respect to the driven gear diameter.

3. The window assembly of claim 2, wherein the drive gear diameter extends from near the interior portion to near the sash.

4. The window assembly of claim 1, wherein a surface area of the sash measures around 23 square feet.

5. The window assembly of claim 1, wherein the window drive mechanism includes:
a worm gear;
a drive gear rotatably coupled with the worm gear; and
a driven gear rotatably coupled with the drive gear, and the driven gear is rotatably coupled with the at least one arm.

6. The window assembly of claim 1, wherein the at least one arm extends to a distal end, the distal end of the at least one arm including a slide thereon.

7. The window assembly of claim 6, wherein the sash further comprising a track, and the track receives the slide, and allows for movement of the sash.

8. A window assembly comprising:
a frame including an interior portion, and the interior portion has an inner surface;
a sash movably coupled with the frame, and the inner surface is substantially parallel with the sash when the sash is in a closed position; and
a window drive mechanism coupled between the frame and the sash, and the window drive mechanism includes a single arm rotatably coupled between the frame and the sash, and the window drive mechanism is entirely contained between the inner surface and the sash.

9. The window assembly of claim 8, wherein the window drive mechanism includes:
a worm gear;
a drive gear rotatably coupled with the worm gear; and
a driven gear rotatably coupled with the drive gear, and the driven gear is rotatably coupled with the single arm.

10. The window assembly of claim 8, wherein the at least one arm extends to a distal end, the distal end of the at least one arm including a slide thereon.

11. The window assembly of claim 10, wherein the sash further comprising a track, and the track receives the slide, and allows for movement of the sash.

12. The window assembly of claim 8, wherein the window drive mechanism includes an input gear and a driven gear, the input gear diameter smaller with respect to the driven gear diameter.

13. The window assembly of claim 12, wherein the drive gear diameter extends from near the interior portion to near the sash.

14. A method of making a window assembly comprising:
movably coupling a sash with a frame, and the frame includes an interior portion having an inner surface substantially parallel with the sash when the sash is in a closed position; and
coupling a window drive mechanism between the sash and the frame, and the window drive mechanism includes at least one arm rotatably coupled between the frame and the sash, and the window drive mechanism is substantially disposed between the sash and a plane defined by an inner surface of the frame.

15. The method of making the window assembly of claim 14, wherein coupling the window drive mechanism includes coupling a driven gear with a housing, a driven gear diameter extending from near the interior portion to near the sash.

16. The method of making the window assembly of claim 15, wherein coupling the window drive mechanism includes coupling an input gear with the housing, the input gear diameter less than the driven gear diameter.

17. The method of making the window assembly of claim 14, further comprising rotating a crank on the window drive mechanism and moving the sash into an open position.

18. The method of making the window assembly of claim 17, wherein rotating the crank on the window drive mechanism includes rotating the crank ten or fewer times to open the sash 90 degrees or more relative to the frame.

19. The method of making the window assembly of claim 18, wherein rotating the crank on the window drive mechanism includes rotating the crank seven or fewer times to open the sash 90 degrees or more relative to the frame.
